(19) United States
(12) Patent Application Publication
(10) Pub. No.: US 2008/0116360 A1
(43) Pub. Date: May 22, 2008

(54) IMAGE INPUT DEVICE

(76) Inventor: Seiji NAKAYAMA, Iizuka-Shi (JP)

Correspondence Address: LADAS & PARRY LLP, 224 SOUTH MICHIGAN AVENUE, SUITE 1600, CHICAGO, IL, 60604, US

(21) Appl. No.: 11/866,493

(22) Filed: Oct. 3, 2007

(30) Foreign Application Priority Data
Nov. 17, 2006 (JP) 2006-311936

(51) Int. Cl. G01J 1/04; H01J 3/14; H01S 4/00

(52) U.S. Cl. 250/227.11; 250/216; 29/592.1; 250/221

(57) ABSTRACT

In an image input apparatus for detecting an image of a fingertip by irradiating the light rays emitted from a light emitting device and transmitting the light rays from the fingertip through an image guide guiding the light rays, the lighting efficiency is improved, power consumption is reduced, and the assembly is facilitated. An image input apparatus according to the present invention includes a main substrate; a lighting module, mounted on the main substrate, including a sub substrate having a light emitting device covered with resin; and an imaging unit, mounted on the main substrate, forming an image based on light rays from an object to be imaged, irradiated by light rays emitted from the light emitting device.

### BACKGROUND OF THE INVENTION

1. Field of the Invention

The present invention generally relates to an image input apparatus, and more particularly to an image input apparatus that irradiates light rays emitted by a light emitting device to a fingertip, directs the light image from the fingertip through an image guide guiding the light rays to an imaging device, and detects the image of the fingertip.

2. Description of the Related Art

Recently, security in the information communication field has been required to be improved. Under the circumstances, there is a demand for mounting a biometric sensor on an electric device such as a computer and a mobile communication device such a cell phone. As a biometric sensor, a sweep-type fingerprint sensor capable of being downsized has been gathering attention.

A conventional sweep-type fingerprint sensor generally includes an image guide, made up of a bundle of optical fibers, disposed on a line-type imaging device and is provided so that the light rays emitted from a light emitting device and passed through a fingertip are transmitted into the optical fibers. In this case, some light rays passed through the fingertip are directly transmitted into the fiber where the ridge of the fingerprint is in directly contact with the end surface of the fibers, and the other light rays are also transmitted into the fibers but through air gap due to the valley of the fingertip. In this case, because of the difference in the refractive index between the air gap and the skin (fingertip ridge), as a result, a larger amount of light rays transmitted through the ridge of the fingertip are transmitted down to the imaging device provided at the opposite end of the fibers, thereby forming the image of the fingerprint (see, for example, Patent Document Nos. 1 and 2).

FIG. 7 shows a cut-open side view of an exemplary fingerprint detection apparatus in the prior art.

A conventional sweep-type fingerprint detection apparatus 10 generally includes a light emitting device 12, a light lead block 13, an image guide 14, and imaging device 15 mounted on a main substrate 11, and they are covered with light-blocking resin 16.

The light emitting device 12 is made up of, for example, a photodiode and emits light rays. The light rays emitted from the light emitting device 12 are transmitted to the light lead block 13. The light lead block 13 is fixed on the light emitting device 12 with a light-transparent resin binder and guides the light rays from the light emitting device 12 up to the fingertip 20.

The light rays guided to the fingertip 20 are reflected at the fingertip 20 and then guided in the image guide 14. The image guide 14 is typically arranged so that the light rays from, for example, the valley of a fingerprint or air gap substantially be reflected but the light rays from the skin (the ridge of the fingerprint) substantially be incident on the image guide 14. The image guide 14 transmits the incident light rays down to the imaging device 15. The imaging device 15 converts the received light rays transmitted through the image guide 14 into an electronic signal with regard to the each imaging line of the imaging device 15.

By the above configuration, a fingerprint image with respect to each line can be formed. Patent Document 1: U.S. Pat. No. 4,932,776 Patent Document 2: Japanese Application Publication No. 2005-118289

However, in the fingerprint detection apparatus in the related art, the light rays emitted by the light emitting device 12 mounted on the main substrate 11 are guided to the fingertip through the light lead block 13, the light rays may be attenuated by the light lead block 13 and higher brightness of the light emitting device is required to be increased to compensate the attenuation, thereby disadvantageously causing problems including the increase of power consumption.

Further, the light lead block 13 is arranged to be fixed on the light emitting device 12 with the light-transparent binder. Because of the structure, when an insufficient light-transparent binder is applied, for example, an air gap may be generated. In this case, when the light-blocking resin is introduced for covering, the light-blocking resin may penetrate into the air gap, thereby blocking light rays so that sufficient light rays may not be transmitted up to the fingertip 20. Further, when heat is applied, the air gap may be expanded and, as a result, the light emitting device 12 may be damaged.

Further, in a case where thermoreversible transmissive molded resin is used as the light lead block 13, since the heat resistance of the resin is low, the light lead block 13 may be deformed upon being heated in, for example, a soldering reflow process. Therefore, any heating process such as the soldering reflow process cannot be performed. As a result, a specific process without heating or heating at lower temperature is to be performed, and the cost is disadvantageously increased.

The present invention is made in light of the above-mentioned problems, and may provide an image input apparatus capable of increasing the illumination efficiency, reducing power consumption, and facilitating the assembly and a manufacturing method of such an image input apparatus.

According to one aspect of the present invention, there is provided an image input apparatus including a main substrate (111); a lighting module (112), mounted on the main substrate (111), including a sub substrate (121) having light emitting devices (122, 123) covered with resin; and imaging unit (113, 114), mounted on the main substrate (111), forming an image based on light rays from an object to be imaged irradiated by light rays emitted from the light emitting devices (122, 123).

According to another aspect of the present invention, there is provided an image input apparatus in which the light emitting devices (122, 123) in the lighting module (112) are electrically connected to the main substrate (111) through conductive patterns (131-142) formed on the sub substrate (121), and the light emitting devices (122, 123) in the lighting module (112) are covered with transparent or translucent resin.

According to still another aspect of the present invention, there is provided an image input apparatus in which one surface of the main substrate (111), on which the imaging unit (113, 114) and the lighting module (112) are mounted, is covered with light-blocking resin (116).

According to still another aspect of the present invention, there is provided an image input apparatus in which the imaging unit (113, 114) including an image guide (114) substantially transmitting or reflecting light rays from a medium depending on the refractive index of the medium; and an imaging device (113) forming an image from the light rays transmitted through the image guide (114).

According to still another aspect of the present invention, there is provided a method of manufacturing an image input apparatus including an imaging unit (113, 114) and light emitting devices (122, 123), wherein an image of an object to be imaged is formed by the light rays from the object irradiated with light rays emitted by the light emitting devices (122, 123), the method including a step of mounting the imaging unit (113, 114) on a main substrate (111); a step of mounting the light emitting devices (122, 123) on a sub substrate (121), covering the light emitting device (122, 123) with resin, and mounting a lighting module (112) including the covered light emitting devices (122, 123) on the main substrate (111); and a step of covering a surface of the main substrate (111) on which the imaging unit (113, 114) and the lighting module (112) are mounted with light-blocking resin (116).

According to still another aspect of the present invention, there is provided a method of manufacturing an image input apparatus in which the step of mounting the imaging unit (113, 114) on a main substrate (111) includes a step of mounting an imaging device (113) on the main substrate (111); and a step of placing and fixing an image guide (114), substantially transmitting or reflecting light rays from a medium depending on the refractive index of the medium, on the imaging device (113).

It should be noted that the reference numerals described above are for reference purposes only, and shall not limit the scope and spirit of the present invention.

According to an embodiment of the present invention, since both a lighting module, in which a light emitting device mounted on a sub substrate is covered with resin, and an imaging device with an image guide placed on the image guide are mounted on a main substrate, the position of the light emitting device can be placed closer to a sweep surface by the thickness of the substrate and accordingly the light rays emitted by the light emitting device can be more efficiently used when an image of the fingertip is formed.

Further, since the light emitting device is covered with resin, the stress applied to the light emitting device can be reduced and damage to the light emitting device can be accordingly avoided.

### BRIEF DESCRIPTION OF THE DRAWINGS

FIG. 1 is a perspective view of an exemplary fingerprint detection apparatus according to one embodiment of the present invention;

FIG. 2 is a partially exploded perspective view of the exemplary fingerprint detection apparatus according to one embodiment of the present invention;

FIGS. 3A through 3F are drawings showing the exemplary fingerprint detection apparatus according to one embodiment of the present invention;

FIG. 4 is a drawing showing an exemplary lighting module according to one embodiment of the present invention;

FIGS. 5A and 5B are drawings illustrating a manufacturing method of a fingerprint detection apparatus 100;

FIGS. 6A and 6B are drawings illustrating a manufacturing method of the fingerprint detection apparatus 100; and

FIG. 7 is a cut-open side view of an exemplary fingerprint detection apparatus in prior art.

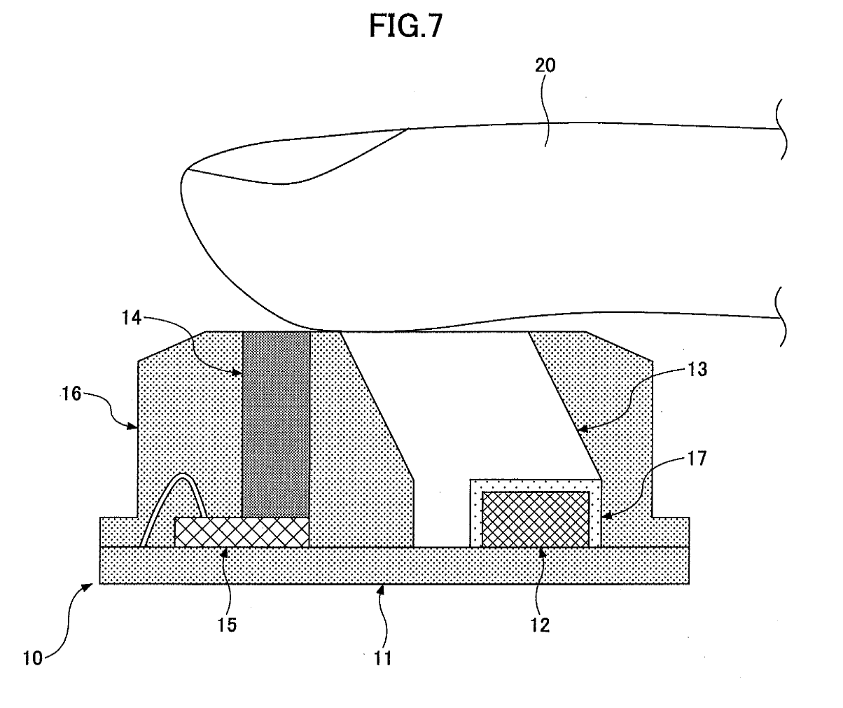

### DETAILED DESCRIPTION OF THE PREFERRED EMBODIMENTS

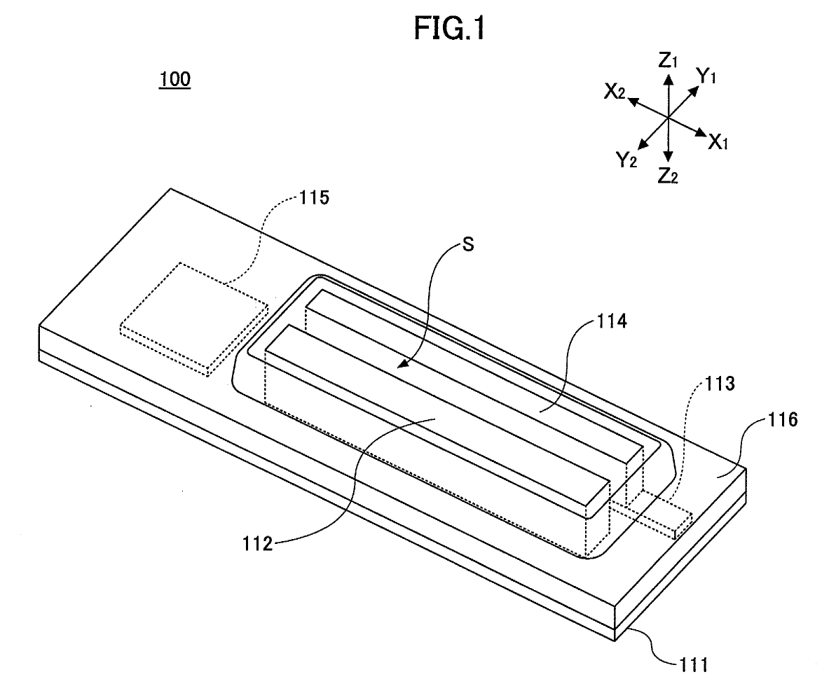

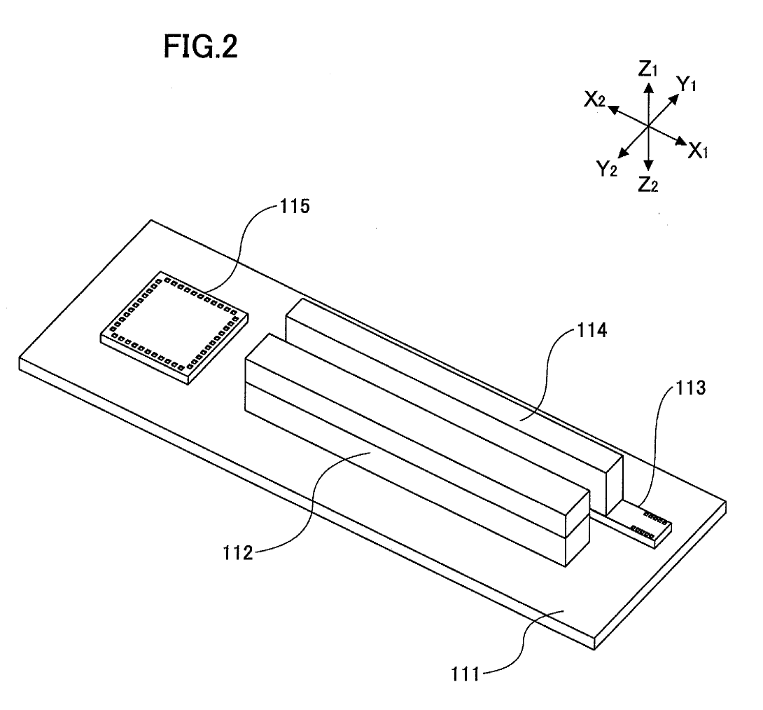

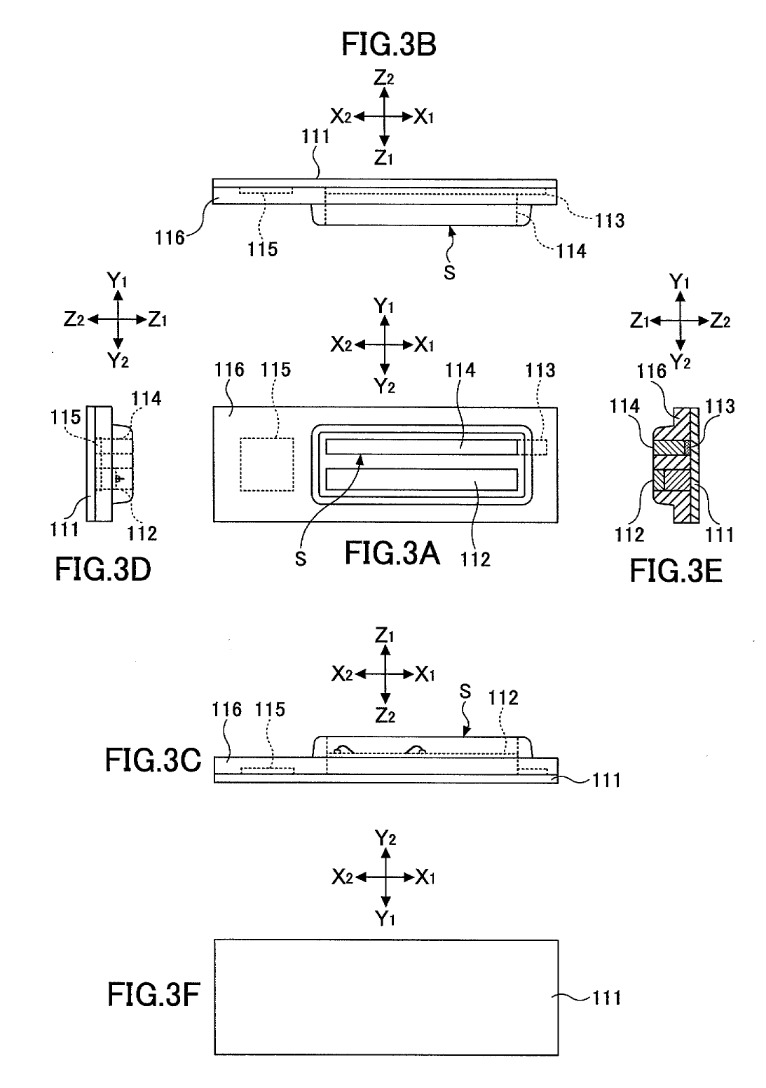

FIG. 1 is a perspective view of an exemplary fingerprint detection apparatus according to one embodiment of the present invention. FIG. 2 is an exploded perspective view of a main part of the exemplary fingerprint detection apparatus according to one embodiment of the present invention. FIGS. 3A through 3F are drawings showing an exemplary fingerprint detection apparatus according to one embodiment of the present invention.

A fingerprint detection apparatus 100 according to an embodiment of the present invention is a so-called sweep-type fingerprint detection apparatus that detects the fingerprint of a fingertip by moving the fingertip in the direction substantially perpendicular to the direction of the detection line of the apparatus. The finger print detection apparatus 100 includes a main substrate 111, a lighting module 112, an imaging device 113, an image guide 114, a system controller 115, and light-blocking molded resin 116.

The main substrate 111 is made up of a printed wiring board on which the lighting module 112, the imaging device 113, and the system controller 115 are mounted. The lighting module 112, the imaging device 113, and the system controller 115 are electrically connected to each other through wiring patterns formed on the main substrate 111.

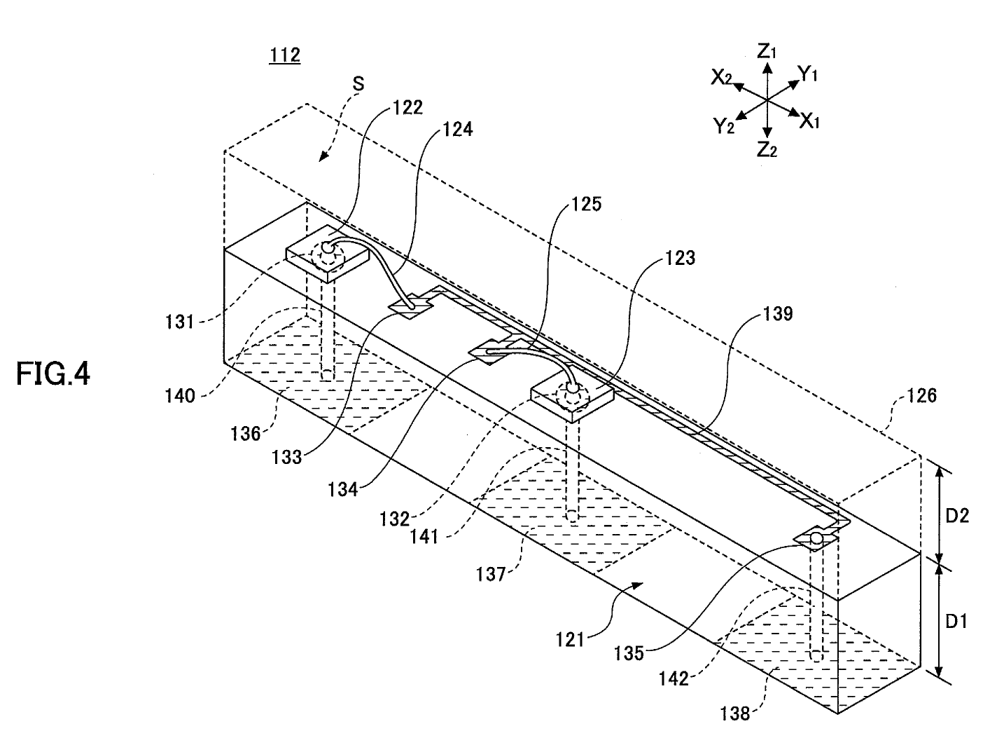

FIG. 4 shows a configuration of the lighting module 112.

The lighting module 112 includes a sub substrate 121, light emitting devices 122, 123, wires 124, 125, and translucent molded resin 126 and emits light rays toward the fingertip driven by power supplied from the main substrate 111.

The sub substrate 121 is made up of, for example, glass epoxy resin. Connection pads 131 through 135 and a connection pattern 139 are formed on the Z1 arrow direction surface of the sub substrate 121.

The light emitting device 122 is made up of, for example, a photodiode. The anode of the photodiode is connected to the connection pad 131. The cathode of the photodiode is connected to the connection pad 133 through the wire 124. Similarly, the light emitting device 123 includes, for example, a photodiode like that of the light emitting device 122. The anode of the photodiode is connected to the connection pad 132. The cathode of the photodiode is connected to the connection pad 134 through the wire 125.

The connection pad 131 is connected to the connection pad 136 formed on the Z2 arrow direction surface of the sub substrate 121 by a through hole plug 140. The connection pad 132 is connected to the connection pad 137 formed on the Z2 arrow direction surface of the sub substrate 121 by a through hole plug 141.

The connection pads 133, 134 are connected to the connection pad 135 formed on the Z1 arrow direction surface of the sub substrate 121 by the wiring pattern 139. The connection pad 135 is connected to the connection pad 138 formed on the Z2 arrow direction surface of the sub substrate 121 by the through hole plug 142.

The surface of the sub substrate 121 on which the light emitting devices 122, 123 are mounted, that is the surface of Z1 arrow direction of the sub substrate 121, is covered with the translucent molded resin 126. As the translucent molded resin 126, for example, heat-hardening resin or translucent white epoxy resin may be used. The translucent molded resin 126 diffuses the light emitted by the light emitting devices 122, 123.

Due to the sub substrate 121, the light emitting devices 122, 123 can be placed closer to a sweep surface S. Because of this feature, the light emitted by the light emitting devices 122, 123 can be effectively transmitted to the fingertip. Further, the translucent molded resin 126 can protect the light emitting devices 122, 123 and the wires 124, 125. In this configuration, the thickness D1 of the sub substrate 121 and the thickness D2 of the translucent molded resin 126 are appropriately arranged so that the distance between the sweep surface S and the wires 124, 125 be a prescribed distance, for example, approximately 0.3 mm through 0.6 mm when the lighting module 112 is mounted on the main substrate 111. The prescribed distance between the sweep surface S and the wires 124, 125 is determined so that the wires 124, 125 can be protected against static electricity generated on the sweep surface S. For example, when the distance between the sweep surface S and the wires 124, 125 is approximately 0.4 mm, about 20 kV of electrostatic discharge resistance protection can be secured.

Further, in the lighting module 112, since the light emitting devices 122, 123, and the wires 124,125 are previously covered with the translucent molded resin 126, for example, an air gap can hardly be formed. Therefore, for example, the penetration of the light-blocking molded resin 116 can be prevented. Further, the expansion of an air gap due to heat, stress on the light emitting devices 122, 123 and wires 124, 125 and accordingly the damage to the light emitting devices 122, 123 and the cutting of wires 124, 125 can be prevented.

As described above, when a lighting part is manufactured as a module to form the lighting module 112, and the lighting module 112 is mounted on the main substrate 111, the reliability is improved compared with a case where a light emitting apparatus is mounted on a main substrate and a light lead block is fixed with, for example, a binder.

In the description, one lighting module 112 is mainly considered and described. However, it should be noted that the lighting module 112 may be formed by mounting the light emitting devices 122, 123 on the printed wiring board on which plural connection pads 131 through 135, a connection pattern 139, and through hole plugs 140 through 142 are formed; performing wire bonding to provide wires 124, 125 to the light emitting devices 122, 123, covering with translucent molded resin 126, and cutting the printed wiring board. The lighting module 112 is provided as a single electric part when the fingerprint detection apparatus 100 is manufactured.

The lighting module 112 is mounted on the main substrate 111 with a conductive binder, such as the Ag paste, applied to either the connection pads 136, 137, 138 or the patterns on the main board 111 opposite to the connection pads 136, 137, 138 and fixed to the main substrate by heating.

The imaging device 113 includes, for example, a line-type light-receiving device such as a phototransistor or a phototransistor arranged in one or plural lines and is mounted on the main substrate 111 so that the light-receiving devices are arranged in the X1 and X2 arrow directions.

The imaging device 113 is die bonded on a prescribed pattern formed on the main substrate 111, and is electrically connected to the system controller 115. The imaging device 113 operates based on, for example, a clock and control signals from the system controller 115, receives the light rays emitted from the other side of the image guide 114, and converts the received light rays into an electronic signal with respect to each line of the imaging device 113. The converted signal in the imaging device 113 is transmitted to the system controller 115.

The image guide 114 is formed by bundling and fixing plural optical fibers and the fibers on the sweep surface S are typically tilted with respect to the extending direction of the fibers. One surface of the image guide 114 is fixed to the imaging device 113 such that the surface faces the light-receiving part of the imaging device 113. The opposite end surface of the image guide 114 is formed as a sweep surface S on which a fingertip is swept. It should be noted that the angle of the above tilt is appropriately determined such that light rays from an air gap is substantially reflected on the sweep surface S of the image guide 114 but light rays from skin be substantially entered into the image guide 114 and transmitted down to the surface facing the image device 113.

The light emitted from the lighting module 112 is incident on the fingertip. The light rays reflected from the fingertip enter into the surface on the sweep surface S of the image guide 114. In this case, light rays enter into the sweep surface S of the image guide 114 directly from an air gap or the skin depending on whether the light rays pass through the valley or ridge of the fingerprint, respectively.

The system controller 115 controls the emission of the light rays from the emitting devices 122,123 in the lighting module 112, and the reading of images by the imaging device 113. Further, the system controller 115 is connected to a host apparatus and controls the communications with the host apparatus.

The imaging device 113, the lighting module 112, the image guide 114, and the system controller 115 mounted on the Z1 arrow direction surface of the main substrate 111 are covered with the light-blocking molded resin 116. The light-blocking molded resin 116 includes black resin and prevents the light rays emitted from the lighting module 112 and surrounding light rays from entering directly into the imaging device 113.

According to an embodiment of the present invention, the light emitting devices 122, 123 can be placed closer to the sweep surface S by adjusting the thickness of the sub substrate 121. Therefore, the light rays emitted by the light emitting devices 122, 123 can be used efficiently. Further, the influence of static electricity can be reduced by adjusting the thicknesses of the substrate 121 and the translucent molded resin 126.

Next, a manufacturing method of the fingerprint detection apparatus 100 is described.

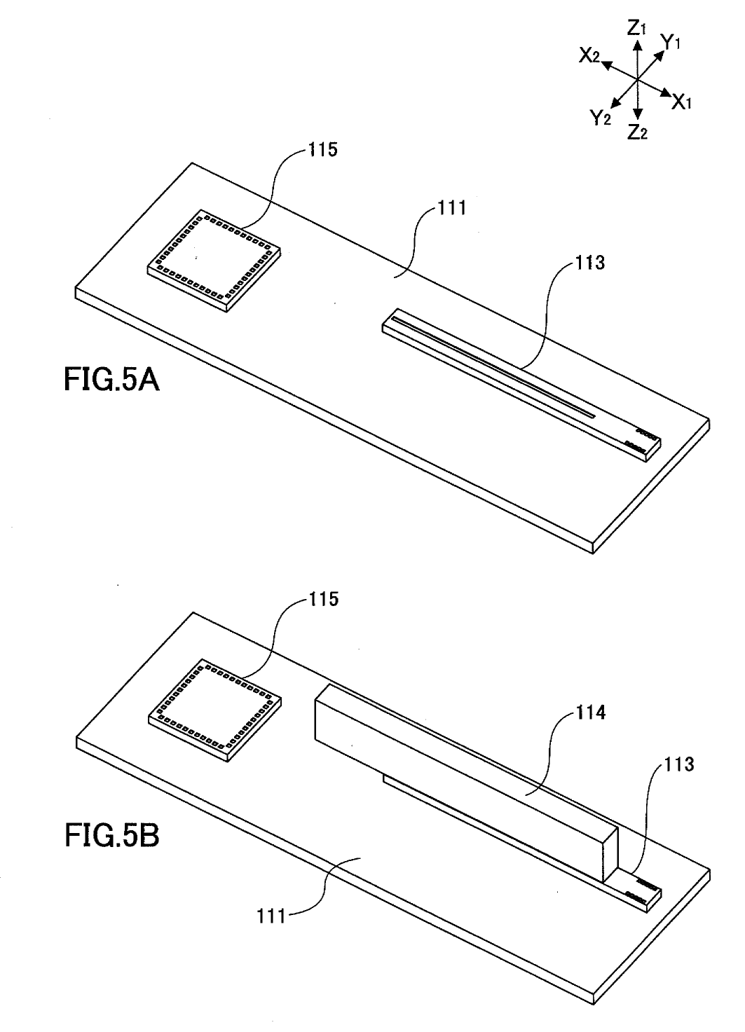

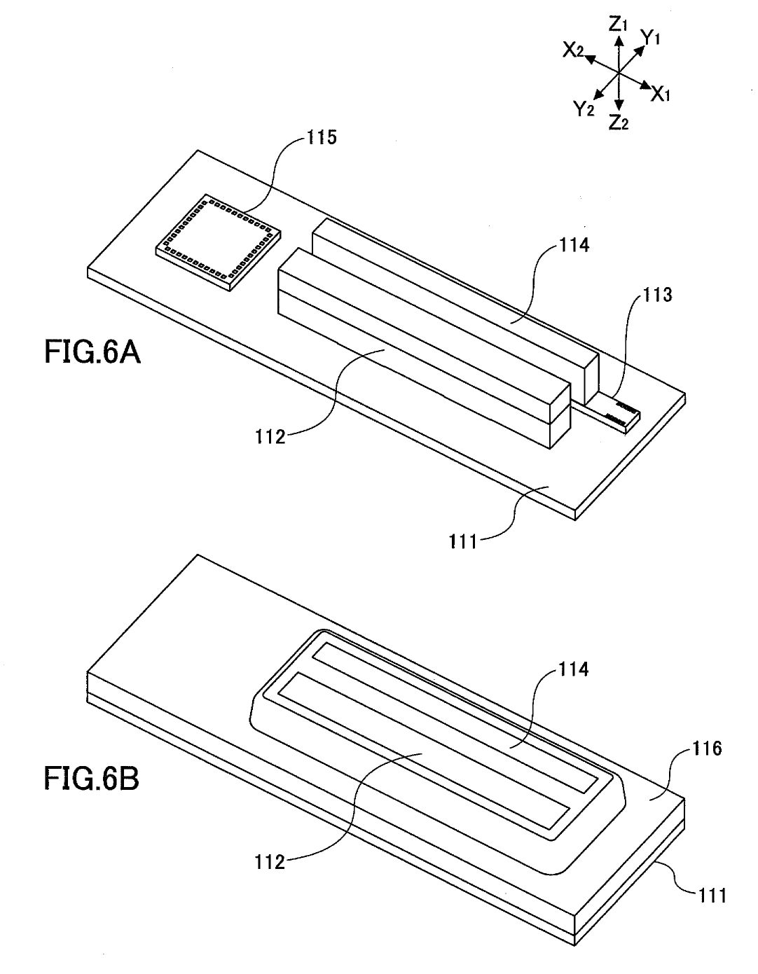

FIGS. 5A and 5B and FIGS. 6A and 6B are drawings illustrating an exemplary manufacturing method of the fingerprint detection apparatus 100.

First, as shown in FIG. 5A, the imaging device 113 and the system controller 115 are mounted on the main substrate 111.

Next, as shown in FIG. 5B, the image guide 114 is placed on and fixed to the light-receiving device of the imaging device 113. Further, as shown in FIG. 6A, the lighting module 112 is mounted on the main substrate 111 with a conductive binder, such as Ag paste, applied to the connection pattern of the main substrate and is fixed to the main substrate 111 by heating.

Next, as shown in FIG. 6B, the surface of the main substrate 111 on which the lighting module 112, the imaging device 113, the image guide 114, and the system controller 115 are mounted, that is the Z1 arrow direction surface of the main substrate 111, is covered with light-blocking resin 116.

A manufacturing method featuring one fingerprint detection apparatus is described with reference to FIGS. 5A and 5B and FIGS. 6A and 6B. However, it should be noted that the lighting module 112 may be formed by mounting plural sets of the light modules 112, the imaging devices 113, the image guides 114, and the system controllers 115 on the printed wiring board of the main substrate 111, covered with the light-blocking resin 116, and cutting the printed wiring board to cut out one fingerprint detection apparatus 100 as shown in FIGS. 5A and 5B and FIGS. 6A and 6B.

Though an exemplary embodiment is described in detail above, the present invention is not limited to the specific embodiment described above, and variations and modification may be made without departing from the spirit and scope of the present invention.

The present invention is based on Japanese Priority Application No. 2006-311936 filed Nov. 17, 2006, the entire contents of which are hereby incorporated herein by reference.

What is claimed is:

1. An image input apparatus comprising:
a main substrate;
a lighting module, mounted on the main substrate, including a sub substrate having a light emitting device covered with resin; and
an imaging unit, mounted on the main substrate, forming an image based on light rays from an object to be imaged irradiated by light rays emitted from the light emitting device.

2. The image input apparatus according to claim 1, wherein the light emitting device in the lighting module is electrically connected to the main substrate through a conductive pattern formed on the sub substrate.

3. The image input apparatus according to claim 1, wherein the light emitting device in the lighting module is covered with transparent or translucent resin.

4. The image input apparatus according to claim 1, wherein one surface of the main substrate on which the imaging unit and the lighting module are mounted is covered with light-blocking resin.

5. The image input apparatus according to claim 1, wherein the imaging unit includes:
an image guide substantially transmitting or reflecting light rays from a media depending on the refractive index of the medium; and
an imaging device forming an image from the light rays transmitted through the image guide.

6. A method of manufacturing an image input apparatus including an imaging unit and a light emitting device, wherein an image of an object to be imaged is formed by light rays from the object irradiated with light rays emitted by the light emitting device, the method comprising:
a step of mounting the imaging unit on a main substrate;
a step of mounting the light emitting device on a sub substrate, covering the light emitting device with resin, and mounting a lighting module including the covered light emitting device on the main substrate; and
a step of covering a surface of the main substrate on which the imaging unit and the lighting module are mounted with light-blocking resin.

7. The method of manufacturing an image input apparatus according to claim 6, wherein the step of mounting the imaging unit on the main substrate includes:
a step of mounting an imaging device on the main substrate; and
a step of placing and fixing an image guide, substantially transmitting or reflecting light rays from a medium depending on the refractive index of the medium, on the imaging device.
